(19) United States
(12) Patent Application Publication
(10) Pub. No.: US 2008/0304399 A1
(43) Pub. Date: Dec. 11, 2008

(54) RECORDING MEDIUM, REPRODUCING APPARATUS, AND METHOD OF MANUFACTURING RECORDING MEDIUM

(75) Inventor: Goro Fujita, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/128,958

(22) Filed: May 29, 2008

(30) Foreign Application Priority Data
Jun. 5, 2007 (JP) 2007-149157

(51) Int. Cl. G11B 7/00; B05D 3/00; C08F 2/46

(52) U.S. Cl. 369/275.1; 427/299; 427/521

(57) ABSTRACT

A recording medium is disclosed. The recoding medium includes a recording layer on which binary data is recorded, and a reflecting layer. The recording layer includes a recording portion having a flat portion and a concave portion. The flat portion and the concave portion are formed on the surface of the recording portion. The flat portion is configured to represent first data of the binary data, and the concave portion is configured to represent second data of the binary data. The reflecting layer is formed on one side of the recording layer.

### CROSS REFERENCES TO RELATED APPLICATIONS

The present invention contains subject matter related to Japanese Patent Application JP 2007-149157 filed in the Japanese Patent Office on Jun. 5, 2007, the entire contents of which being incorporated herein by reference.

### BACKGROUND OF THE INVENTION

1. Field of the Invention

The present invention relates to a recording medium, a reproducing apparatus, and a method of manufacturing a recording medium.

2. Description of the Related Art

As a next-generation optical disc that follows a CD (Compact Disc), a DVD (Digital Versatile Disc), and a Blu-ray Disc of this age, a system of recording a standing wave on a medium has been proposed.

For example, light is focused once on a medium whose refractive index changes depending on an intensity of irradiated light, and thereafter is focused again on the same focal position from an opposite side by using a reflecting apparatus provided on a back surface of the medium as an optical disc. As a result, a small hologram of a light spot size is formed on the medium, to thereby record information.

In the same way, for reproduction, reflected light of light irradiated from a surface of the optical disc is read, to thereby determine information.

Further, recording information on the medium in a layered manner makes it possible to collectively record, on the medium, information generally recorded on the same number of optical discs as the layers (see, for example, R. R. McLeod et al., “Microholographic multilayer optical disk data storage”, Appl, opt., Vol. 44, 2005, pp. 3197-3207).

### SUMMARY OF THE INVENTION

However, for example, in a case of a ROM (Read Only Memory) dedicated to reproduction, in which information is recorded on the medium in the layered manner, it takes more than a day to manufacture the ROM having as many as, e.g., 20 recording layers by forming the hologram mentioned above. This is because it normally takes several hours to manufacture a layer. Even when a dedicated writer is used to enable an increase of rpm and a simultaneous record on multiple layers, it is difficult to manufacture the ROM in a short time. Further, a cost reduction is difficult in terms of a cycle time, and thus it is difficult to manufacture large amounts of ROMs, on which information is recorded, at a low cost.

In view of the above-mentioned circumstances, it is desirable to provide a recording medium, a reproducing apparatus, and a method of manufacturing a recording medium which can realize large-volume production at a low cost.

According to an embodiment of the present invention, there is provided a recording medium. The recording medium includes a recording layer on which binary data is recorded, and a reflecting layer. The recording layer includes a recording portion having a flat portion and a concave portion. The flat portion and the concave portion are formed on a surface of the recording portion. The flat portion is configured to represent first data of the binary data. The concave portion is configured to represent second data of the binary data. The reflecting layer is formed on a first side of the recording layer.

In the embodiment of the present invention, the recording medium includes the recording layer including the recording portion having the surface, the flat portion formed on the surface and configured to represent the first data of the binary data, and the concave portion formed on the surface and configured to represent the second data of the binary data. Therefore, when the recording medium is irradiated with light and reflection light is read, a refractive index of the flat portion on the surface of the recording layer and a refractive index of, e.g., air in the concave portion are different from each other. Due to the difference of the refractive indexes, the flat portion and the concave portion causes different reflection light beams. Thus, the difference of the reflection light beams allows discrimination of the binary data. Further, the concave portion can be easily formed by pressing the recording layer with a stamper or the like. Thus, the cycle time is reduced, which can manufacture large amounts of recording media at a low cost.

According to the embodiment of the present invention, in the recording medium, a plurality of recoding layers is stacked. With this structure, for example, each recording layer is pressed with the stamper or the like to form the concave portion, to thereby significantly reduce the cycle time, which can manufacture large amounts of recording media, on which a lot of information is recorded, at a low cost.

According to the embodiment of the present invention, the recording medium further includes an address layer formed on a second side of the recording layer. With this structure, when information recorded on the recording medium is read, a track is determined based on information of the address layer.

According to the embodiment of the present invention, in the recording medium, the concave portion is filled with air. With this structure, the refractive index of the recording layer and the refractive index of, e.g., air in the concave portion are different from each other. Therefore, based on the difference, the binary data can be discriminated.

According to the embodiment of the present invention, in the recording medium, the concave portion is filled with an inert gas. With this structure, the inert gas can prevent a surface of the concave portion from corroding.

According to the embodiment of the present invention, in the recording medium, the concave portion is filled with a material obtained by curing a liquid material. With this structure, a more stable state can be obtained as compared with a case where a material in the concave portion has a liquid form.

According to the embodiment of the present invention, in the recording medium, the material is a UV curable resin. With this structure, the concave portion is filled with the UV curable resin and the UV curable resin is irradiated with UV light, thereby making it possible to easily cure the UV curable resin.

According to the embodiment of the present invention, in the recording medium, the concave portion has a depth of equal to or less than 4λn/NA² μm and has a diameter of equal to or less than 1.22λ/NA μm, in which NA represents a numerical aperture of an objective lens optically communicated with the recording medium, n represents a refractive index of the recording layer, and λ represents a wavelength of light irradiated on the recording medium. With this structure, when NA is 0.50, n is 1.5, and the wavelength is 0.405, for example, the concave portion can be prevented from malfunctioning as the recording mark due to its excessive size.

According to the embodiment of the present invention, in the recording medium, the concave portion has a depth of equal to or less than 10 μm and has a diameter of equal to or less than 1 μm. With this structure, a case where the depth thereof exceeds 10 μm and the diameter thereof exceeds 1 μm can be eliminated. Thus, the concave portion can be prevented from malfunctioning as the recording mark due to its excessive size.

According to another embodiment of the present invention, there is provided a reproducing apparatus configured to reproduce a recording medium on which binary data is recorded, the recording medium including a recording layer and a reflecting layer. The recording layer includes a recording portion having a flat portion and a concave portion. The flat portion and the concave portion are formed on a surface of the recording portion. The flat portion is configured to represent first data of binary data. The concave portion is configured to represent second data of the binary data. The reflecting layer is formed a first side of the recording layer. The reproducing apparatus includes an irradiation unit configured to irradiate the recording portion with light from a second side of the recording layer, and a detector configured to detect reflection light reflected on the recording layer.

In the embodiment of the present invention, the irradiation unit irradiates the recording portion with the light from the second side of the recording layer. The detector detects reflection light beams different from each other due to the difference between the refractive index of the recording layer and the refractive index of, e.g., air in the concave portion. Therefore, the binary data can be discriminated.

According to another embodiment of the present invention, there is provided a method of manufacturing a recording medium. The method includes forming a recording portion on a surface of a member that constitutes the recording layer with a stamper, the recording portion having the surface, a flat portion, and a concave portion, the flat portion and the concave portion being formed on the surface, the flat portion being configured to represent first data of binary data, the concave portion being configured to represent second data of the binary data, and forming a reflecting layer on a first side of the recording layer.

In the embodiment of the present invention, when the recording portion is formed on the member so as to include the flat portion that represents the first data and the concave portion that represents the second data, the member that constitutes the recording layer is pressed with the stamper from the surface. The operation with the stamper is simple and not time-consuming. Repetition of the operation with the stamper more than one time makes it possible to easily manufacture large amounts of recording media in a short time.

According to the embodiment of the present invention, the method of manufacturing a recording medium further includes layering a plurality of recording layers. Therefore, when, for example, the recording layer is pressed with the stamper to form the concave portion on each recording layer, the cycle time is significantly reduced, which can manufacture large amounts of recording media, on which a lot of information is recorded, at a low cost.

According to the embodiment of the present invention, the method of manufacturing a recording medium further includes forming an address layer on a second side of the recording layer. Therefore, when information recorded on the recording medium is read, a track can be determined based on the information of the address layer.

According to the embodiment of the present invention, in the method of manufacturing a recording medium, the plurality of recording layers is layered in an inert gaseous atmosphere. Therefore, the concave portion is filled with the inert gas in each of the plurality of recording layers having been formed. Therefore, a reaction between the recording layer and the inert gas can be prevented, resulting in prevention of corrosion of the recording layer.

According to the embodiment of the present invention, the method of manufacturing a recording medium further includes supplying a liquid material onto the member which constitutes the recording layer after the concave portion is formed on the member, and rotating the member to spin off the liquid material while the liquid material is caused to remain in the concave portion. Therefore, a simple operation of supplying the liquid material and rotating the member can easily cause the concave portion to be filled with the liquid material.

According to the embodiment of the present invention, in the method of manufacturing a recording medium, the liquid material is a UV curable resin. The method further includes layering a plurality of recording layers after the liquid material is spun off, and irradiating the UV curable resin with UV light. Therefore, the UV curable resin between the recording layers is irradiated with UV light and cured, with the result that a stable state can be easily obtained.

According to the embodiment of the present invention, in the method of manufacturing a recording medium, the liquid material is a foaming agent. The method further includes layering a plurality of recording layers after the liquid material is spun off, and heating the foaming agent. Therefore, after the liquid material is spun off, the foaming agent is heated to foam the foaming agent in the concave portion. Thus, the size of the concave portion can be increased. As a result, the function of the concave portion as the recording mark can be enhanced, for example.

As described above, according to the embodiments of the present invention, large amounts of recording media can be manufactured at a lot cost.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a sectional diagram showing an optical disc (ROM) according to a first embodiment;

FIG. 2 is a block diagram showing an optical disc reproducing apparatus that reproduces the optical disc;

FIG. 3 is a block diagram showing an optical system of an optical pickup of the optical disc reproducing apparatus;

FIG. 4 is an optical path diagram I in the optical pickup at the time of reproduction;

FIG. 5 is an optical path diagram II in the optical pickup at the time of reproduction;

FIG. 6 is a diagram for explaining a focal position in the optical disc at the time of reproduction;

FIG. 7 is a flowchart of manufacturing the optical disc (ROM) according to the first embodiment;

FIG. 8 is a diagram for explaining a step of molding a substrate (Step 1 of FIG. 7);

FIG. 9 is a diagram for explaining a step of forming a reflection-transmission layer (Step 2 of FIG. 7);

FIG. 10 is a diagram for explaining a step of coating a material of a first recording layer (Step 3 of FIG. 7);

FIG. 11 is a diagram for explaining a step of forming the first recording layer (Step 4 of FIG. 7);

FIG. 12 is a diagram for explaining a step of coating a material of a second recording layer (Step 5 of FIG. 7);

FIG. 13 is a diagram for explaining a step of forming the second recording layer (Step 6 of FIG. 7);

FIG. 14 is a diagram for explaining a step of forming a plurality of recording layers (Step 7 of FIG. 7);

FIG. 15 is a diagram for explaining a step of forming a reflecting layer (Step 8 of FIG. 7);

FIG. 16 is a sectional diagram of an optical disc (ROM) according to a second embodiment;

FIG. 17 is a flowchart of manufacturing the optical disc (recording medium; ROM) according to the second embodiment;

FIG. 18 is a diagram for explaining a step of coating a UV curable resin (Step 4′ of FIG. 17);

FIG. 19 is a diagram for explaining a step of spinning off a UV curable resin (Step 4′ of FIG. 17);

FIG. 20 is a diagram for explaining a step of forming a second recording layer (Step 6′ of FIG. 17); and

FIG. 21 is a sectional diagram of an optical disc (ROM) according to a third embodiment.

### DESCRIPTION OF PREFERRED EMBODIMENTS

Hereinafter, embodiments of the present invention will be described with reference to drawings.

### First Embodiment

(Structure of Optical Disc)

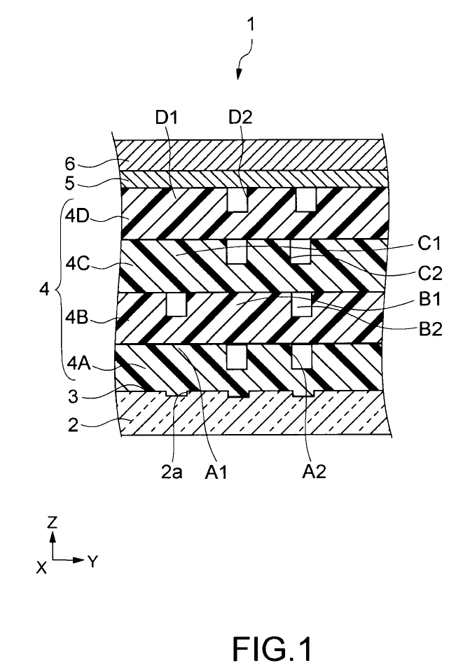

FIG. 1 is a sectional diagram showing an optical disc (ROM) 1 as a recoding medium of a first embodiment.

The optical disc 1 has, for example, a discoid shape in which a hole (not shown) is formed at a center portion thereof and whose diameter is about 120 mm.

As shown in FIG. 1, the optical disc 1 includes a substrate 2, a reflection-transmission layer 3, a recording layer 4, a reflecting layer 5, and a protection film 6 layered therein. The recording layer 4 records information as binary data.

The substrate 2 is made of a material such as polycarbonate and glass. The substrate 2 transmits incident light from one side to the other side at a high transmissivity. Further, the substrate 2 has intensity sufficient to protect the recording layer 4.

The reflection-transmission layer 3 is a dielectric multilayer, for example. The reflection-transmission layer 3 transmits a blue light beam Lb whose wavelength is 405 nm and reflects a red light beam Lr whose wavelength is 660 nm at a predetermined ratio. The reflection-transmission layer 3 is formed on the substrate 2 by sputtering or the like, and serves as an address layer (reference surface) to which the red light beam Lr is irradiated, as described later.

The recording layer 4 includes, for example, four recording layers (a first recording layer 4A, a second recording layer 4B, a third recording layer 4C, and a fourth recording layer 4D) layered therein. It is to be noted that the number of layers is not limited and may be less or more than four.

The first recording layer 4A is made of a resin material whose refractive index is, e.g., 1.5. A thickness of the first recording layer 4A is, e.g., 30 μm. The first recording layer 4A includes a recording portion having a flat portion A1 and a concave portion A2. The flat portion A1 represents first data of binary data. The concave portion A2 represents second data of the binary data. The binary data means “0” and “1”, for example. The flat portion represents “0” and the concave portion represents “1”.

The concave portion A2 has a depth of equal to or less than 10 μm and a diameter (width) of equal to or less than 1 μm. More specifically, it is preferable that the concave portion A2 have the depth of 6 μm and the diameter (width) of 0.6 μm. A maximum value of the depth of the concave portion A2 is determined by 4nλ/NA², in which λ (m) represents the wavelength of the blue light beam Lb, NA represents a numerical aperture of an objective lens 26 to be described later, and n represents a refractive index of the objective lens 26. In the same way, a maximum value of the diameter (width) of the concave portion A2 is determined by λ/NA. The preferable values are assumed to be about 60% of the maximum values in consideration of interference between marks and a crosstalk between layers in order to increase a recording density.

The concave portion A2 is filled with air, for example. It is to be noted that the concave portion A2 may be filled with an inert gas such as nitrogen or argon, instead of air. As a result, the inside of the concave portion A2 can be prevented from corroding due to a gas.

The second recording layer 4B, the third recording layer 4C, and the fourth recording layer 4D are structured in the same manner as the first recording layer 4A. They are provided with recording portions, respectively. On the recording portions of the second to fourth recording layers 4B to 4D, a flat portion B1 and a concave portion B2, a flat portion C1 and a concave portion C2, and a flat portion D1 and a concave portion D2 are formed, respectively. Further, the concave portions B2, C2, and D2 are filled with air (or the inert gas).

The reflecting layer 5 is disposed so as to be superimposed on the fourth recording layer 4D, and is made of a material such as aluminum and silver. The reflecting layer 5 is formed by vacuum deposition, for example.

The protection film 6 is disposed on, for example, an outer side of the reflecting layer 5 in order to secure reliability of the reflecting layer 5.

(Structure of Optical Disc Reproducing Apparatus)

Next, an optical disc recording/reproducing apparatus 10 that reproduces the optical disc 1 is described with reference to the drawing.

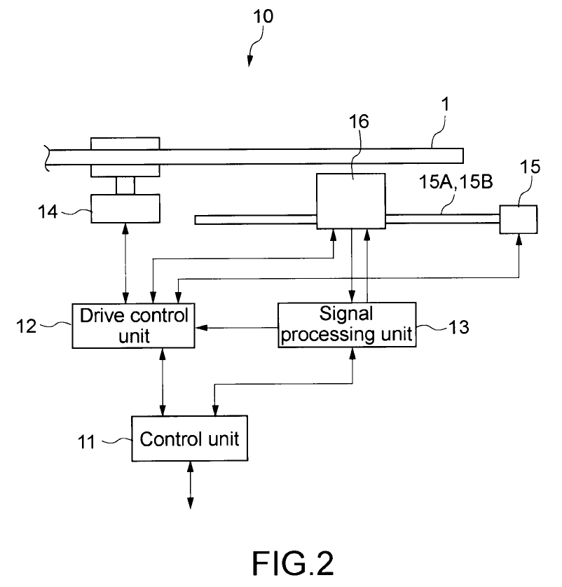

FIG. 2 is a block diagram showing the optical disc recording/reproducing apparatus 10 that reproduces the optical disc 1.

As shown in FIG. 2, the optical disc recording/reproducing apparatus 10 includes a control unit 11, a drive control unit 12, a signal processing unit 13, a spindle motor 14, a sled motor 15, and an optical pickup 16. The control unit 11 controls the optical disc recording/reproducing apparatus 10. That is, the control unit 11 controls the drive control unit 12 and signal processing unit 13.

As shown in FIG. 2, the control unit 11 receives a reproduction instruction and reproduction address information from an external apparatus (not shown) with the optical disc 1 loaded. Then, the control unit 11 supplies a drive instruction to the drive control unit 12 and supplies the reproduction instruction to the signal processing unit 13. Further, the control unit 11 receives reproduction information from the signal processing unit 13 and sends the reproduction information to the external apparatus (not shown).

The drive control unit 12 performs a drive control on the spindle motor 14 in accordance with the drive instruction, to thereby rotate the optical disc 1 at a predetermined rpm. Further, the drive control unit 12 performs a drive control on the sled motor 15, to thereby move the optical pickup 16 to a position corresponding to the reproduction address information along movement shafts 15A and 15B.

The signal processing unit 13 performs a predetermined demodulation processing or the like on a signal read by the optical pickup 16 from the optical disc 1 to thereby generate a reproduction signal, and supplies the reproduction signal to the control unit 11.

The optical pickup 16 is provided to the movement shafts 15A and 15B in order to irradiate the optical disc 1 with light from one side with the light focused.

(Structure of Optical Pickup 16)

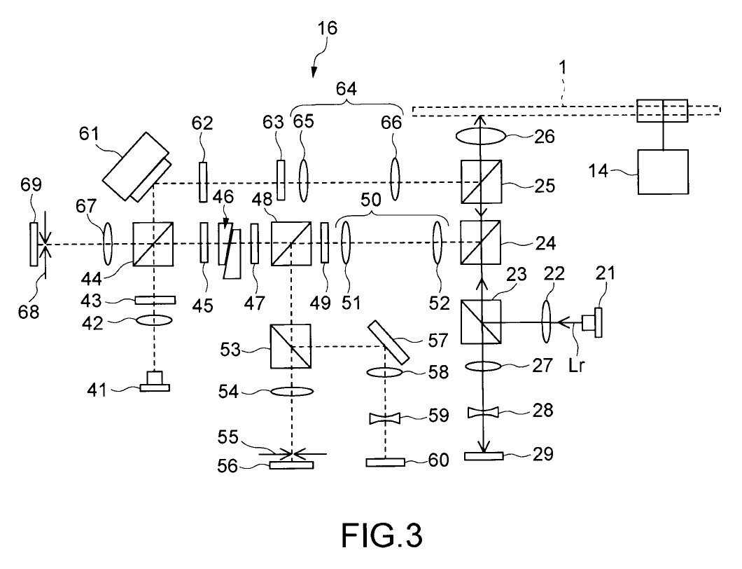

FIG. 3 is a block diagram showing optical systems of the optical pickup 16 of the optical disc recording/reproducing apparatus 10.

The optical systems of the optical pickup 16 include (1) a position control optical system, (2) a first information optical system, and (3) a second information optical system.

The optical disc recording/reproducing apparatus 10 can record a hologram using the first information optical system and the second information optical system while performing a focusing control or a tracking control using the position control optical system at the time of recording. Herein, explained is an example where the optical disc 1 according to the embodiment of the present invention is reproduced using the optical disc recording/reproducing apparatus 10. The optical disc recording/reproducing apparatus 10 can reproduce the optical disc 1 with the first information optical system or the second information optical system.

Hereinafter, each of the optical systems will be described.

(1) Position Control Optical System

The position control optical system mainly controls a position of the objective lens 26 based on the red light beam Lr.

As shown in FIG. 3, the position control optical system includes a laser diode 21, a collimator lens 22, a non-polarization beam splitter 23, a dichroic prism 24, a non-polarization beam splitter 25, the objective lens 26, a condensing lens 27, a cylindrical lens 28, and a photodetector 29.

As shown in FIG. 3, the laser diode 21 emits the red light beam Lr whose wavelength is 660 nm. The laser diode 21 emits a predetermined amount of the red light beam Lr as a divergent light beam based on the control by the control unit 11, and causes the light beam to enter the collimator lens 22.

The collimator lens 22 converts the red light beam Lr from the divergent light beam to a parallel light beam and causes the parallel light beam to enter the non-polarization beam splitter 23.

The non-polarization beam splitter 23 reflects the red light beam Lr on a reflection surface thereof and causes the red light beam Lr to enter the dichroic prism 24.

The dichroic prism 24 transmits the red light beam Lr at a rate of approximately 100% and causes the red light beam Lr to enter the non-polarization beam splitter 25.

The non-polarization beam splitter 25 transmits the red light beam Lr and causes the red light beam Lr to enter the objective lens 26.

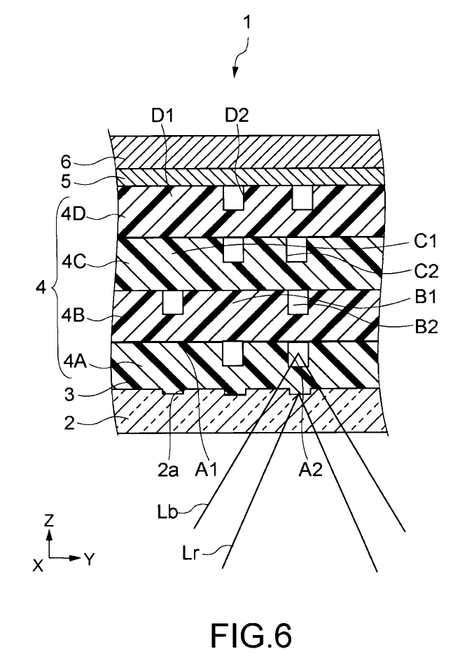

The objective lens 26 condenses the red light beam Lr and irradiates the optical disc 1 with the red light beam Lr. At this time, the red light beam Lr passes through the substrate 2 and is then reflected on the reflection-transmission layer 3 (described later with reference to FIG. 6). After that, the red light beam Lr having been reflected sequentially passes through the objective lens 26, the non-polarization beam splitter 25, the dichroic prism 24, and the non-polarization beam splitter 23, and then enters the condensing lens 27.

The condensing lens 27 converges the red light beam Lr and irradiates the photodetector 29 with the condensing lens 27 caused to have astigmatism by the cylindrical lens 28.

There is a fear that an eccentricity, a runout, or the like of the rotating optical disc 1 may occur in the optical disc recording/reproducing apparatus 10. This may cause a target track position to change. To cause the red light beam Lr to follow the target track, a focus should be moved in a focus direction and a tracking direction. The focus direction is a direction of moving the focal point closer to or away from the optical disc 1, while the tracking direction is a radial direction of the optical disc 1 toward an inner circumferential side or an outer circumferential side. In view of the above, the objective lens 26 is driven in the focus direction and the tracking direction by a biaxial actuator (not shown).

The photodetector 29 includes four lattice-like detection areas (not shown) and sends a detection signal detected in each detection area to the signal processing unit 13. The signal processing unit 13 performs a focus control by an astigmatic method and supplies a focus error signal to the drive control unit 12, for example. The drive control unit 12 generates a focus drive signal based on the focus error signal, supplies the focus drive signal to the biaxial actuator (not shown), and focuses the red light beam Lr on the reflection-transmission layer 3 (focus control). In addition, the signal processing unit 13 performs tracking control by a push-pull method and supplies a tracking error signal to the drive control unit 12. The drive control unit 12 generates a tracking drive signal based on the tracking error signal, supplies the tracking drive signal to the biaxial actuator (not shown), and focuses the red light beam Lr on the target track (tracking control).

(2) First Information Optical System

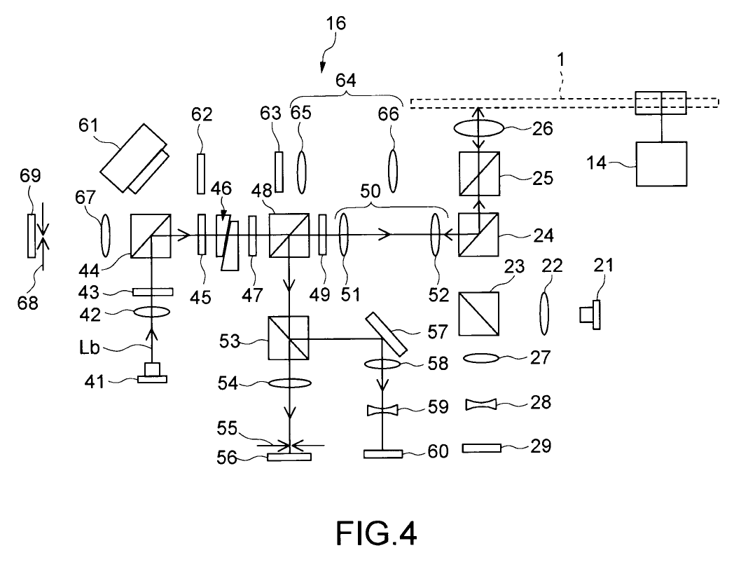

FIG. 4 is an optical path diagram I in the optical pickup when reproducing the optical disc 1.

The first optical system irradiates the optical disc 1 with the blue light beam Lb and detects a blue reproduction light beam reflected on the optical disc 1.

The first information optical system includes a laser diode 41, a collimator lens 42, a half wave plate 43, a polarization beam splitter 44, a shutter 45, an anamorphic prism 46, a half wave plate 47, a polarization beam splitter 48, a quarter wave plate 49, a relay lens system 50, the dichroic prism 24, the non-polarization beam splitter 25, the objective lens 26, a non-polarization beam splitter 53, a condensing lens 54, a pinhole plate 55 and a photodetector 56, a reflection mirror 57, a condensing lens 58, a cylindrical lens 59, and a photodetector 60.

The laser diode 41 emits the blue light beam Lb whose wavelength is about 405 nm. The laser diode 41 emits the blue light beam Lb as a divergent light beam based on the control of the control unit 11, and causes the light beam to enter the collimator lens 42.

The collimator lens 42 converts the blue light beam Lb from the divergent light beam into a parallel light beam and causes the parallel light beam to enter the half wave plate 43.

The half wave plate 43 turns the polarization direction of the blue light beam Lb by predetermined angles so as to obtain p-polarization components of about 50% and s-polarization components of about 50%, for example, and causes the resultant blue light beam Lb to enter the polarization beam splitter 44.

The polarization beam splitter 44 reflects the incident blue light beam Lb depending on the polarization direction and causes the light beam to enter the shutter 45.

The shutter 45 shuts off or transmits the blue light beam Lb based on the control of the control unit 11. For example, when the shutter 45 transmits the blue light beam Lb, the shutter 45 causes the blue light beam Lb to enter the anamorphic prism 46.

The anamorphic prism 46 shapes the intensity of the incident blue light beam Lb and causes the incident blue light beam Lb to enter the half wave plate 47.

The half wave plate 47 turns the polarization direction of the blue light beam Lb by predetermined angles so as to obtain p-polarization components of about 50% and s-polarization components of about 50%, for example, and causes the resultant blue light beam Lb to enter the polarization beam splitter 48.

The polarization beam splitter 48 transmits or reflects the blue light beam Lb depending on the polarization direction, for example. The blue light beam Lb having been transmitted is caused to enter the quarter wave plate 49.

The quarter wave plate 49 converts the incident light beam from a linear polarization (p-polarization) into a circular polarization, and causes the converted light beam to enter the relay lens system 50.

The relay lens system 50 includes a movable lens 51 and a fixed lens 52. The movable lens 51 converts the blue light beam Lb from the parallel light beam into the convergent light beam. Then, the convergent light beam change into the divergent light beam. The fixed lens 52 converts the blue light beam Lb obtained as the divergent light beam into the convergent light beam again to be caused to enter the dichroic prism 24.

After that, the blue light beam Lb, approximately 100% of which is reflected on the dichroic prism 24, is transmitted through the non-polarization beam splitter 25, the objective lens 26, the recording layer 4 of the optical disc 1, the objective lens 26, the non-polarization beam splitter 25, the dichroic prism 24, the relay lens system 50, and the quarter wave plate 49 in succession, reflected on the polarization beam splitter 48, and caused to enter the non-polarization beam splitter 53.

The non-polarization beam splitter 53 causes the incident blue light beam Lb to enter the condensing lens 54. The condensing lens 54 condenses the blue light beam Lb and irradiates the photodetector 56 with the condensed blue light beam Lb through the pinhole plate 55.

Further, the non-polarization beam splitter 53 causes the incident blue light beam Lb to enter the reflection mirror 57.

The reflection mirror 57 reflects the incident blue light beam Lb and causes the reflected blue light beam Lb to enter the condensing lens 58.

The condensing lens 58 converges the incident blue light beam Lb and irradiates the photodetector 60 with the condensing lens 58 caused to have astigmatism by the cylindrical lens 59.

(3) Second Information Optical System

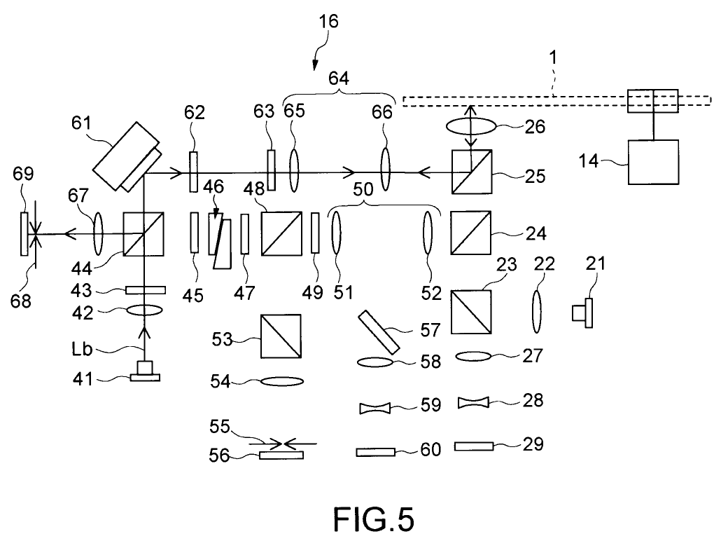

FIG. 5 is an optical path diagram II in the optical pickup when reproducing the optical disc 1.

The second information optical system irradiates the optical disc 1 with the blue light beam Lb and detects a blue reproduction light beam reflected on the optical disc 1.

The second information optical system includes the laser diode 41, the collimator lens 42, the half wave plate 43, the polarization beam splitter 44, a galvano mirror 61, a shutter 62, a quarter wave plate 63, a relay lens system 64, the non-polarization beam splitter 25, the objective lens 26, a condensing lens 67, a pinhole plate 68, and a photodetector 69.

The blue light beam Lb emitted from the laser diode 41 is caused to pass through the collimator lens 42 and the half wave plate 43 and enter the polarization beam splitter 44 in the same manner as the optical path I of FIG. 4.

The polarization beam splitter 44 transmits a part of the incident blue light beam Lb and causes the transmitted light beam to enter the galvano mirror 61.

The galvano mirror 61 can change a reflection surface thereof. By adjusting angles of the reflection surface in accordance with the control of the control unit 11, the traveling direction of the blue light beam Lb can be adjusted.

The shutter 62 shuts off or transmits the blue light beam Lb based on the control of the control unit 11. For example, when the blue light beam Lb is transmitted, the shutter 62 causes the transmitted blue light beam Lb to enter the quarter wave plate 63.

The quarter wave plate 63 converts the incident light beam from, for example, the linear polarization (p polarization) into the circular polarization, and causes the converted light beam to enter the relay lens system 64.

The relay lens system 64 includes a movable lens 65 and a fixed lens 66. The movable lens 65 converts the blue light beam Lb from the parallel light beam into the convergent light beam. The convergent light beam change into the divergent light beam. The fixed lens 66 converts the blue light beam Lb as the divergent light beam into the convergent light beam again to be caused to enter the non-polarization beam splitter 25.

After that, the blue light beam Lb reflected on the non-polarization beam splitter 25 is transmitted through the objective lens 26, the recording layer 4 of the optical disc 1, the objective lens 26, the non-polarization beam splitter 25, the relay lens system 64, the quarter wave plate 63, the shutter 62, and the galvano mirror 61 in succession, reflected on the polarization beam splitter 44, and caused to enter the condensing lens 67.

The condensing lens 67 condenses the incident blue light beam Lb and irradiates the photodetector 69 with the condensed light beam through the pinhole plate 68.

Next, a reproduction operation of the optical disc recording/reproducing apparatus 10 will be described with reference to the drawing.

FIG. 6 is a diagram for explaining a focal position in the optical disc 1 at the time of reproduction.

When information recorded on the optical disc 1 is reproduced, the control unit 11 of the optical disc recording/reproducing apparatus 10 emits the red light beam Lr so as to focus on the reflection-transmission layer 3 of the optical disc 1, as shown in FIG. 6. Based on a detection result of the reflection light, the control unit 11 then causes the drive control unit 12 to perform a focus control and a tracking control on the objective lens 26.

Further, the control unit 11 controls the shutter 62 shown in FIG. 4 or the shutter 45 shown in FIG. 5, thereby making it possible to shut off light. As a result, the blue light beam Lb emitted from the laser diode 41 is caused to travel on an optical path shown in FIG. 4 or an optical path shown in FIG. 5.

Further, the control unit 11 adjusts the position of the movable lens 51 of the relay lens system 50, to thereby focus the blue light beam Lb on a concave portion A2, for example.

As a result, the blue light beam Lb is reflected at the concave portion A2 of the recording layer 4, for example, to thereby generate blue reproduction light beam.

When the blue reproduction light beam enters the photodetector 56, a detection signal is generated based on data of the blue reproduction light beam. The signal processing unit 13 performs a predetermined demodulation processing or the like on the detection signal to generate a reproduction signal, and sends the reproduction signal to the control unit 11.

The control unit 11 performs a predetermined information integration processing to integrate a plurality of reproduction information items into one, and sends the integrated information to an external apparatus (not shown).

(Method of Manufacturing Optical Disc 1)

Next, a method of manufacturing the optical disc 1 of this embodiment will be described with reference to the drawings.

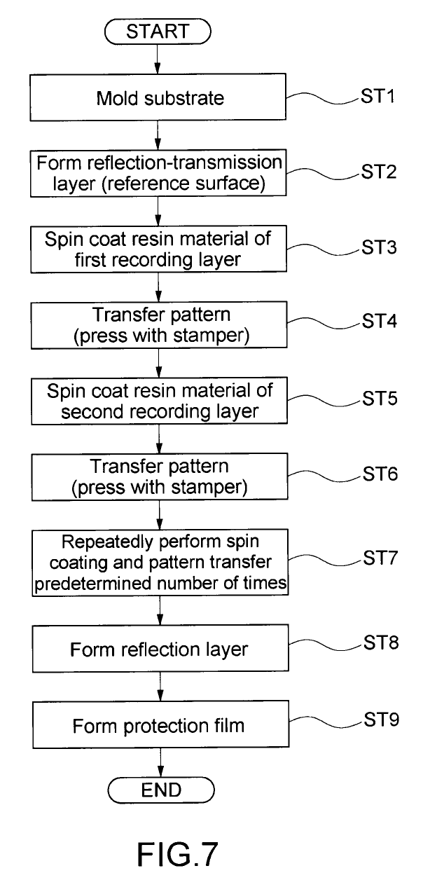

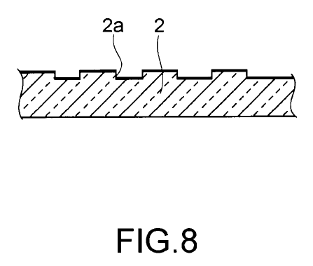

FIG. 7 is a flowchart of manufacturing the optical disc 1 according to the first embodiment. It should be noted that FIGS. 8 to 15 are diagrams for explaining each step (Steps 1 to 8) of FIG. 7.

First, as shown in FIG. 8, the substrate 2 on which a groove-like concave portion 2a is formed is molded (Step 1). The substrate 2 is made of a glass substrate or the like.

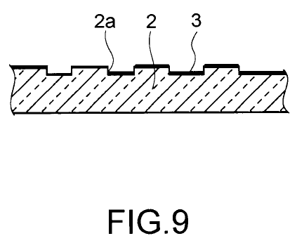

Next, as shown in FIG. 9, the reflection-transmission layer 3, which is, e.g., a dielectric multilayer, is formed, by sputtering, on the substrate 2 on a side where the concave portion 2a is formed (Step 2).

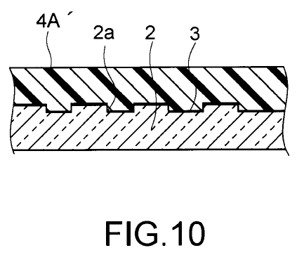

Subsequently, as shown in FIG. 10, a resin material 4A′ that forms the first recording layer 4A is spin-coated, for example, on the reflection-transmission layer 3 (Step 3).

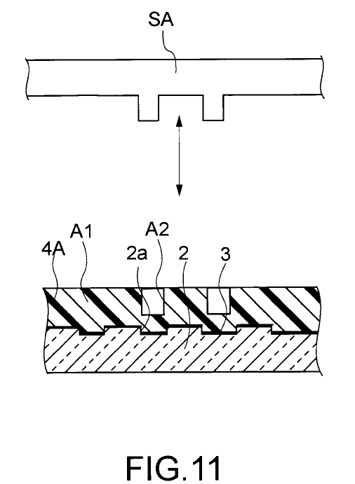

Next, as shown in FIG. 11, the resin material 4A′ of FIG. 10 is pressed with a stamper SA (Step 4). Thus, the flat portion A1 and the concave portion A2 are formed on the resin material 4A′ to form the first recording layer 4A.

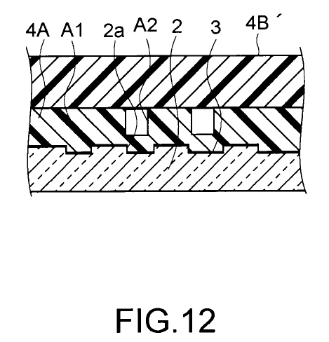

Next, as shown in FIG. 12, a resin material 4B′ that forms the second recording layer 4B is spin-coated, for example, on the first recording layer 4A (Step 5).

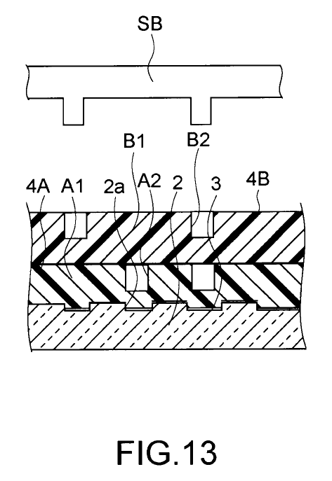

Next, as shown in FIG. 13, the resin material 4B′ is pressed with a stamper SB (Step 6). Thus, a flat portion B1 and a concave portion B2 are formed on the resin material 4B′ to form the second recording layer 4B. In this case, the concave portion A2 is filled with air, for example.

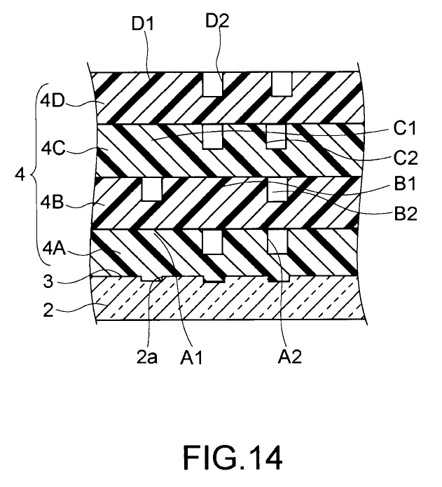

The same steps as Steps 5 and 6 are repeatedly executed a predetermined number of times, to thereby form recording layers (the third recording layer 4C and the fourth recording layer 4D) by the predetermined number as shown in FIG. 14 (Step 7).

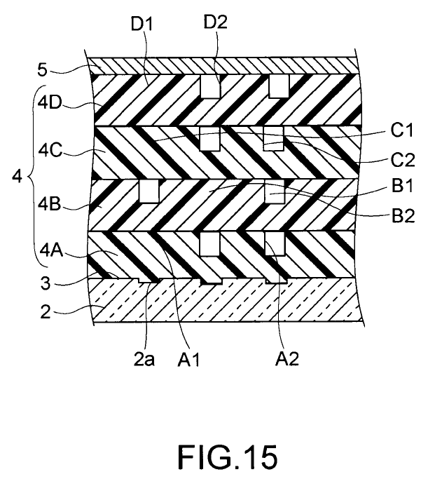

After that, as shown in FIG. 15, the reflecting layer 5 is formed by vacuum deposition, sputtering, or the like (Step 8), and a protection film 6 is formed so as to cover the reflecting layer 5. As a result, the optical disc 1 is manufactured.

As described above, according to this embodiment, the optical disc 1 includes the first recording layer 4A including a recording portion on which the flat portion A1 representing first data of binary data and the concave portion A2 representing second data of the binary data are formed. Therefore, when the optical disc 1 is irradiated with the blue light beam Lb and the reflected light is read by the optical pickup 16, reproduction light beams different from each other are generated. This is because the refractive index of the flat portion A1 and the refractive index of, e.g., air in the concave portion A2 are different from each other. Thus, the binary data can be discriminated. Further, by pressing the resin material 4A′ of the first recording layer 4A with the stamper SA, the concave portion A2 can be easily formed. In particular, the recording layer 4 of the optical disc 1 is configured by layering the first to fourth recording layers 4A to 4D. When the operation with the stamper is performed in a short time in manufacturing the optical disc 1, the cycle time is significantly reduced and large amounts of optical discs 1 on which high-volume information is recorded can be manufactured at a low cost.

The optical disc 1 further includes the reflection-transmission layer 3 as an address layer formed on the other side of the first recording layer 4A. Thus, when information recorded on the optical disc 1 is read, a track can be determined based on the information of the reflection-transmission layer 3.

Further, the concave portion A2 has a depth of equal to or less than 10 μm and a diameter (width) of equal to or less than 1 μm. With this structure, a case where the depth thereof exceeds 10 μm and the diameter thereof exceeds 1 μm can be eliminated. Thus, the concave portion A2 can be prevented from malfunctioning as a recording mark due to its excessive size.

Further, the optical recording/reproducing apparatus 10 includes the laser diode 41 and the photodetectors 56 and 69. The laser diode 41 irradiates the recording portion with light from the other side of the recording layer 4 of the optical disc 1. The photodetectors 56 and 69 detect the reflected light from the recording layer 4. With this structure, the laser diode 41 irradiates the recording portion of the recording layer 4 of the optical disc 1 with the blue light beam Lb, and the photodetector 56 detects reproduction light beams which are different due to the difference between the refractive index of the recording layer 4 and the refractive index of, e.g., a gas in the concave portion A2, with the result that the binary data can be discriminated.

It is to be noted that this embodiment shows the example in which the concave portions A2, B2, C2, and D2 are filled with air, but may be filled with an inert gas instead of air. With this structure, when the inert gas is in contact with, e.g., the first recording layer 4A and the second recording layer 4B, the first and second recording layers 4A and 4B can be prevented from corroding. For example, the first and second recording layers 4A and 4B may be layered in an inert gaseous atmosphere to obtain this structure.

### Second Embodiment

Next, an optical disc according to a second embodiment and a method of manufacturing the optical disc will be described. It is to be noted that in this embodiment and the following ones, the same constituents and the like as those of the first embodiment are denoted by the same reference symbols. Their descriptions are omitted and different points therefrom will be mainly described.

(Structure of Optical Disc)

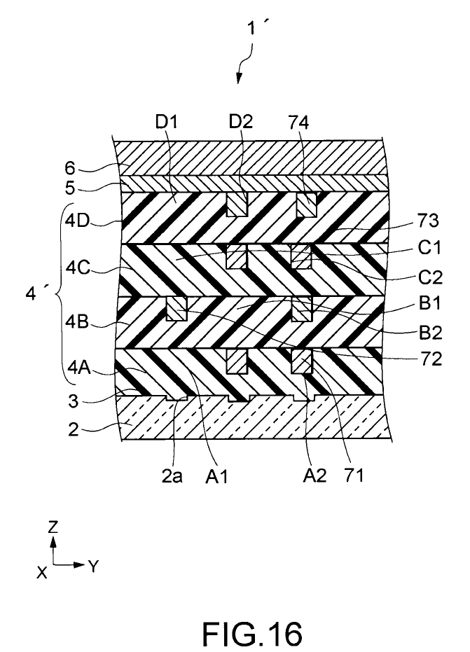

FIG. 16 is a sectional diagram of an optical disc (ROM) 1′ according to the second embodiment.

As shown in FIG. 16, in the optical disc 1′ of this embodiment, the concave portion A2 of the first recording layer 4A is filled with a UV curable resin 71 whose refractive index is different from that of the first recording layer 4A of 1.5. The UV curable resin 71 is filled in a cured, stable state. Similarly, the concave portions B2, C2, and D2 of the second, third, and fourth recording layers 4B, 4C, and 4D are filled with UV curable resins 72, 73, and 74, respectively, whose refractive indexes are different from those of the second, third, and fourth recording layers 4B, 4C, and 4D of 1.5.

(Method of Manufacturing Optical Disc 1′)

Next, a method of manufacturing the optical disc 1′ of this embodiment will be described with reference to the drawings.

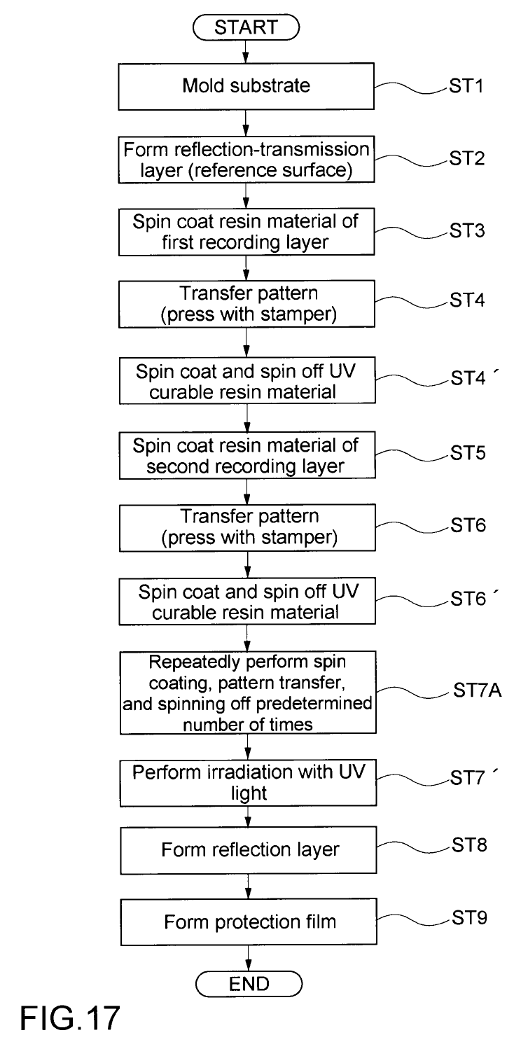

FIG. 17 is a flowchart of manufacturing the optical disc 1′ (recording medium; ROM) according to the second embodiment.

The method of manufacturing the optical disc 1′ of this embodiment is different from that of the first embodiment in the following points. Step 4′ is added after Step 4. Step 6′ is added after Step 6. Step 7 is replaced by Step 7A and Step 7′ is added after Step 7A. Those different steps will be mainly described.

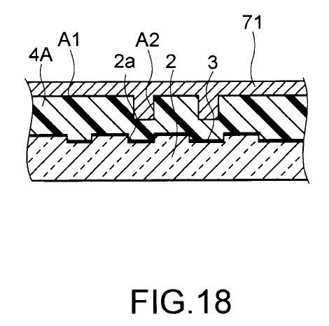

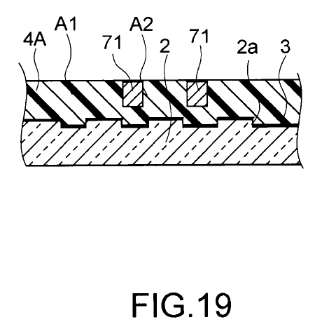

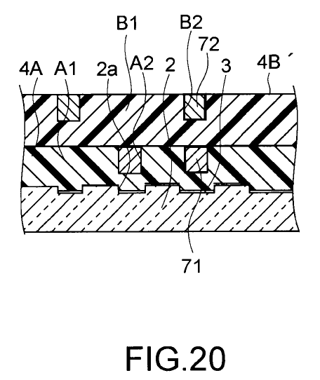

FIGS. 18 and 19 are diagrams for explaining Step 4′ of FIG. 17. FIG. 20 is a diagram for explaining Step 6′ of FIG. 17.

First, in Steps 1 to 4 shown in FIG. 17, as in the first embodiment, the first recording layer 4A on which the concave portion A2 is formed as shown in FIG. 18. After that, the UV curable resin 71 as a liquid material is supplied onto the first recording layer 4A by spin coating or the like as shown in FIG. 18. As a result, the concave portion A2 is filled with the UV curable resin 71. Next, for example, by increasing the rpm of the substrate 2, the UV curable resin 71 on the first recording layer 4A is spun off while being caused to remain in the concave portion A2 (Step 4′) as shown in FIG. 19. Thus, the UV curable resin 71 remains only in the concave portion A2.

Next, as shown in FIG. 20, in Steps 5 and 6, the second recording layer 4B is formed as in the first embodiment. In Step 6′, the concave portion B2 of the second recording layer 4B is filled with the UV curable resin 72 (the UV curable resin 72 is caused to remain in the concave portion B2) as in Step 4′ (Steps 5 to 6′).

Next, Steps 5 to 6′ are repeatedly executed a predetermined number of times, to thereby form a recording layer 4′ including the plurality of recording layers (see FIG. 16) (Step 7A).

Subsequently, UV light is radiated to cure the UV curable resins 71 and 72 (Step 7′).

Then, the reflecting layer 5 and the protection film 6 are formed, with the result that the optical disc 1′ shown in FIG. 16 is manufactured.

As described above, according to this embodiment, the concave portion A2 is filled with the UV curable resin 71 as the liquid material in the cured state. Therefore, the more stable state can be obtained as compared with a case where the concave portion A2 is filled with a material in a liquid form. Further, after the concave portion A2 is formed on the first recording layer 4A, the UV curable resin 71 is supplied onto the first recording layer 4A and the substrate 2 or the like is rotated, to thereby spin off the UV curable resin 71 from the surface of the first recording layer 4A while the UV curable resin 71 is caused to remain in the concave portion A2. As a result, the concave portion A2 can be easily filled with the UV curable resin 71 (the UV curable resin can easily remain in the concave portion A2) with a simple operation of supplying the UV curable resin 71 and rotating the substrate 2. Since, as a material to be supplied in the concave portion A2, the UV curable resin 71 is used, only by irradiating the UV curable resin 71 with UV light, it can be easily cured. Consequently, the cycle time can be reduced.

### Third Embodiment

Next, an optical disc according to a third embodiment of the present invention, and a method of manufacturing the optical disc will be described.

(Structure of Optical Disc)

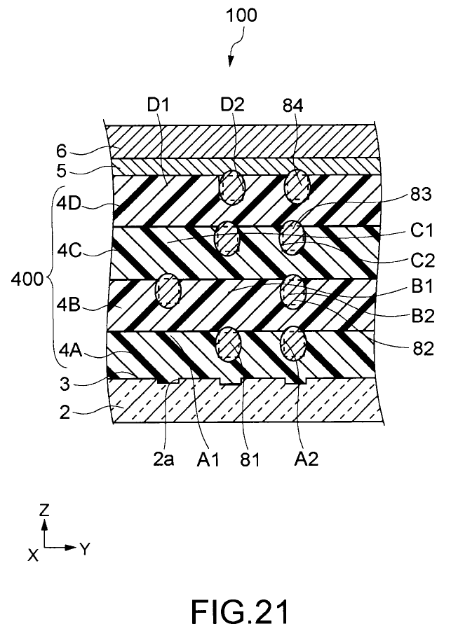

FIG. 21 is a sectional diagram of an optical disc (ROM) 100 according to the third embodiment.

As shown in FIG. 21, in the optical disc 100, the concave portion A2 of the first recording layer 4A is filled with a foaming agent 81 in a foamed and expanded state. Similarly, the concave portions B2, C2, and D2 of the second, third, and fourth recording layers 4B, 4C, and 4D are filled with a foaming agent 82, 83, and 84, respectively, in a foamed and expanded state.

(Method of Manufacturing Optical Disc 100)

In the method of manufacturing the optical disc 100 of this embodiment, the foaming agent 81 as a liquid material is spin-coated and spun off, unlike the method of the second embodiment in which the UV curable resin 71 is spin-coated and spun off in Step 4′ of FIG. 17.

Further, the foaming agent 82 as a liquid material is spin-coated and spun off, unlike the second embodiment in which the UV curable resin 72 is spin-coated and spun off in Step 6′ of FIG. 17. It is to be noted that the same holds true for steps of manufacturing the third and fourth recording layers 4C and 4D.

Then, instead of UV irradiation in Step 7′ of FIG. 17, a recording layer 400 including the foaming agents 81, 82, and the like is heated. As a result, the foaming agents 81 and the like are expanded to expand the concave portions A2 and the like, as shown in FIG. 21.

As described above, according to this embodiment, for example, the concave portion A2 of the first recording layer 4A is filled with the foaming agent 81 in an expanded state by being heated. As a result, the size of the concave portion A2 can be increased in at least, e.g., a depth direction, which can enhance the function of the concave portion A2 as a recording mark. As mentioned above, by controlling the size, shape, and the like of the recording marks formed of the foaming agent 81 and the like, the function as the recording mark can be enhanced.

Further, when heated, the foaming agent 81 and the like can be easily expanded, resulting in reduction of the cycle time. Thus, large amounts of optical discs 100 can be manufactured at a low cost.

The present invention is not limited to the above embodiments, and various changes can be made.

What is claimed is:

1. A recording medium, comprising:
a recording layer on which binary data is recorded, the recording layer including a recording portion having a flat portion and a concave portion formed on a surface of the recording portion, the flat portion being configured to represent first data of the binary data, the concave portion being configured to represent second data of the binary data; and
a reflecting layer formed on a first side of the recording layer.

2. The recording medium as set forth in claim 1,
wherein the recording layer includes a plurality of recoding layers stacked on one another.

3. The recording medium as set forth in claim 1, further comprising
an address layer formed on a second side of the recording layer.

4. The recording medium as set forth in claim 1,
wherein the concave portion is filled with air.

5. The recording medium as set forth in claim 1,
wherein the concave portion is filled with an inert gas.

6. The recording medium as set forth in claim 1,
wherein the concave portion is filled with a material obtained by curing a liquid material.

7. The recording medium as set forth in claim 6,
wherein the material is a UV curable resin.

8. The recording medium as set forth in claim 1,
wherein the concave portion has a depth of equal to or less than 4λn/NA² μm and has a diameter of equal to or less than 1.22λ/NA μm, in which NA represents a numerical aperture of an objective lens optically communicated with the recording medium, n represents a refractive index of the recording layer, and λ represents a wavelength of light irradiated on the recording medium.

9. The recording medium as set forth in claim 1,
wherein the concave portion has a depth of equal to or less than 10 μm and has a diameter of equal to or less than 1 μm.

10. A reproducing apparatus configured to reproduce a recording medium on which binary data is recorded, the recording medium including a recording layer and a reflecting layer, the recording layer including a recording portion having a flat portion and a concave portion formed on a surface of the recording portion, the flat portion being configured to represent first data of the binary data, the concave portion being configured to represent second data of the binary data, the reflecting layer being formed on a first side of the recording layer, comprising:
an irradiation unit configured to irradiate the recording portion with light from a second side of the recording layer; and
a detector configured to detect reflection light reflected on the recording layer.

11. A method of manufacturing a recording medium, comprising:
pressing a surface of a member that constitutes a recording layer with a stamper, to form a flat portion and a concave portion, the flat portion being configured to represent first data of binary data, the concave portion being configured to represent second data of the binary data; and
forming a reflecting layer on a first side of the recording layer.

12. The method of manufacturing a recording medium as set forth in claim 11, further comprising
forming a plurality of recording layers in a layered manner.

13. The method of manufacturing a recording medium as set forth in claim 11, further comprising
forming an address layer on a second side of the recording layer.

14. The method of manufacturing a recording medium as set forth in claim 12,
wherein the step of forming the plurality of recording layers in a layered manner is performed in an inert gaseous atmosphere.

15. The method of manufacturing a recording medium as set forth in claim 11, further comprising:
supplying a liquid material onto the member that constitutes the recording layer, the member being formed with the flat portion and the concave portion; and
rotating the member to spin off the liquid material while the liquid material is caused to remain in the concave portion.

16. The method of manufacturing a recording medium as set forth in claim 15,
wherein the liquid material is a UV curable resin, the method further comprising:
forming a plurality of recording layers in a layered manner after the liquid material is spun off; and
irradiating the UV curable resin with UV light.

17. The method of manufacturing a recording medium as set forth in claim 15,
wherein the liquid material is a foaming agent, the method further comprising:
forming a plurality of recording layers in a layered manner after the liquid material is spun off; and
heating the foaming agent.
